(19) United States
(12) Patent Application Publication
(10) Pub. No.: US 2013/0104847 A1
(43) Pub. Date: May 2, 2013

(54) Fuel Injection Valve and Motor Vehicle Internal Combustion Engine Equipped with the Same

(71) Applicants: Eiji Ishii, Hitachinaka (JP); Masanori Ishikawa, Tsuchiura (JP)

(72) Inventors: Eiji Ishii, Hitachinaka (JP); Masanori Ishikawa, Tsuchiura (JP)

(21) Appl. No.: 13/388,208

(22) PCT Filed: Jul. 19, 2011
(86) PCT No.: PCT/JP2011/066300

§ 371 Date: Jan. 31, 2012

(30) Foreign Application Priority Data
Jul. 22, 2010 (JP) 2010-164633

(51) Int. Cl. F02M 69/04

(52) U.S. Cl. CPC F02M 69/04
USPC 123/445

(57) ABSTRACT

A step height is provided in an upper surface of a nozzle plate. Plural pairs of nozzle holes are provided in the nozzle plate, and thereby a liquid film is formed with fuel liquid columns injected from each pair of nozzle holes. In one nozzle hole, as the step height is placed in the vicinity of the nozzle hole, the direction of the fuel flow is changed to a direction along the surface of the step height, and a swirl flow is formed at its inlet. On the other hand, as the other nozzle hole is away from the step height, thereby a uniform inflow without swirl flow is formed. As a result, the shape of the liquid film is changed to a predetermined pattern liquid film by increase of the pressure.

### TECHNICAL FIELD

The present invention relates to a fuel injection valve to supply a fuel to an internal combustion engine and a motor vehicle internal combustion engine equipped with the fuel injection valve.

Emission standards of motor vehicle-exhaust gas have been tightened through the year. In order to meet such a trend, in a technical field of fuel injection valve equipped in a motor vehicle internal combustion engine, required is fine atomization of fuel and reduction of adhesion of fuel to an inner wall surface of an intake pipe by injecting the fuel toward a target position (e.g., two directions toward intake valves of the internal combustion engine) to reduce noxious emission HC (carbon hydride).

In conventional fuel injection valves, the following techniques are disclosed as a fuel spray pattern control means for injecting a fuel to a target position.

One is a way, as shown in Document D1, of applying swirl forces to respective fuel sprays injected from multiple nozzle holes and making such swirl forces differ from each other on a group-by-group basis in the multiple nozzle holes divided into plural groups. According to this conventional technique, a fuel spray with a large swirl force becomes an injection with a wide spray cone angel capable of promoting fine atomization of the fuel, and a fuel spray with a small swirl force becomes an injection with a narrow spray cone angle capable of promoting a penetration for travel of fuel in a straight-line. According to the combination of these fuel sprays with different swirl forces, a fine-atomized fuel spray can be carried by a fuel spray with a large penetration, and thereby, the reduction of adhesion of the fine atomized fuel spray to the inner wall surface of the intake pipe can be achieved.

Another is a way, as shown in Document D2, of forming a fan-shaped fuel spray pattern by colliding the fuel sprays injected from multiple nozzle holes with each other. Further this way is provided with two needle valves capable of selecting multiple nozzle holes, and by changing selection of the multiple nozzle holes upon stratified charge combustion operation and upon homogeneous combustion operation, it makes possible to change a pattern of the fuel spray.

### DOCUMENTS OF PRIOR ARTS

Document D1: JP 2006-336577A
Document D2: JP 2003-328903A

### SUMMARY OF THE INVENTION

### Tasks to be Solved by the Invention

In the above-described techniques, the way disclosed in the Document D1 teaches of using a fuel spray with a large penetration as one of the combined fuel sprays. According to the way, the one of fuel sprays although can have the large penetration, it tends to be inferior in performance of fine atomization of the fuel to that of the other fuel sprays with a wide spray cone angle of injection. Further, it is difficult to change the spray pattern in correspondence with change of a stroke amount of a valve element such a needle and change of fuel pressure. Next, in the way disclosed in the Document 2, it since uses two needle valves, the structure of the fuel injection valve increases in complexity and thereby increases in the cost of manufacturing products.

The subject of the present invention is to provide a fuel injection valve with a simple structure and capable of control a fuel spray pattern in correspondence with fuel pressure and/or the stroke amount of the valve element and to provide a motor vehicle internal combustion engine equipped with the fuel injection valve.

### Means to Solve the Tasks

To solve the above-mentioned tasks, the present invention is basically configured as follows.

(1) That is, in a fuel injection valve for an internal combustion engine having multiple nozzle holes for fuel injection wherein the nozzle holes are constituted by at least a pair of nozzle holes and configured such that, upon valve opening of the injection valve, liquid columns of fuel injected from the pair of nozzle holes collide with each other before break-up of the liquid columns,

the fuel injection valve further comprises a fuel flow control portion that controls a flow of the fuel flowing into at least one of the pair of nozzle holes so as to make swirl forces of the fuel liquid columns injected from the pair of nozzle holes differ from each other.

(2) Regarding the swirl forces of the fuel liquid columns, for example, the fuel flow control portion is configured to apply a swirl force to a fuel injected from one of the pair of nozzle holes while applying a smaller or little swirl force to a fuel injected from the other of the pair of nozzle holes in comparison with the one nozzle hole. In this manner, those swirl forces from the pair of nozzle holes are set to be different from each other.

Further for example, the fuel flow control portion is configured to make fuel flow velocity distributions in a circumferential direction at inlets of the pair of nozzle holes differ from each other thereby to make the swirl forces between the nozzle holes differ from each other.

(3) For example, the multiple nozzle holes are provided in a nozzle plate. That is, the fuel flow control portion is configured on a top surface of the nozzle plate to be an upstream side surface of the nozzle plate.
3-1) The top surface of the nozzle plate is provided with a step height for making a difference in height on the top surface, and at least one pair of nozzle holes is provided at a lower portion to be a lower surface in the difference in height, wherein one of the pair of nozzle holes at the lower portion is placed close to a wall of the step height such that the inlet of the one of the pair of nozzle holes is subjected to control of the fuel flow with the wall of the step height. In this case, the wall of the step height configures the fuel flow control portion.
3-2) Otherwise, in the top surface of the nozzle plate, the inlet of at least one of the pair of nozzle holes is provided with a countersunk-like hole portion larger than a diameter of the nozzle hole. The countersunk-like hole portion configures the fuel flow control portion by offsetting a center of the countersunk-like hole portion with respect to a center of the nozzle hole provided with the countersunk-like hole portion.
3-3) Otherwise, the top surface of the nozzle plate is provided with a local hollow portion, and the inlet of one of the pair of nozzle hole is placed in the local hollow portion. The local hollow portion has an asymmetric shape with respect to a line connecting between a center of the nozzle plate and the center of the one nozzle hole placed in the local hollow portion, and thereby a part of the inlet of the one nozzle hole is close to a part of an edge wall of the local hollow portion, thus, the edge wall of the local hollow portion configures the fuel flow control portion.
3-4) Otherwise, the top surface of the nozzle plate is provided with a projection, and the inlet of one of the pair of nozzle holes is placed close to the projection, thus, a side wall of the projection configures the fuel flow control portion.
3-5) Otherwise, an end of a movable valve element of the fuel injection valve is provided with a flat face portion and a step height formed at an edge (edges) of the flat face portion, and one of the pair of the nozzle holes is placed close to a wall of the step height of the movable valve element such that the wall of the step height configures the fuel flow control portion.

By employing the above structure, the fuel flow control portion changes distributions and magnitudes of fuel flow velocity components (axis-direction velocity component and swirl velocity component) of the fuel flowing into the pair of nozzle holes, and thereby a difference of swirl components (including a case where zero swirl component is produced in one of the pair of nozzle holes) for the fuel is produced between the pair of nozzle holes. Accordingly, the respective liquid columns of the fuel injected from the pair of nozzle holes can have different kinetic energy respectively. As a result, when the liquid columns of the fuel injected from the pair of nozzle holes collide with each other and thereby a liquid film of the fuel is formed, the liquid film does not have a symmetrical shape with respect to the pair of nozzle holes and thereby the liquid film is deflected to the side of the fuel liquid column with kinetic energy smaller than the other side. When the liquid film is deflected in this manner, the distribution of liquid droplets after break-up of liquid film of the fuel follows a deflecting direction of the liquid film, and thus a fuel spray pattern can be changed.

The swirl components of fuel in the pair of nozzle holes can be controlled by changing the pressure applied to the fuel or the amount of valve stroke. With this arrangement, it is possible to change the fuel spray pattern in correspondence with the fuel pressure or the valve stroke.

### Advantageous Effects of Invention

According to the present invention, it is possible to change the direction and the pattern of the fuel spray in correspondence with the fuel pressure or the valve stroke, without deterioration of atomization for fuel spray, with a simple structure.

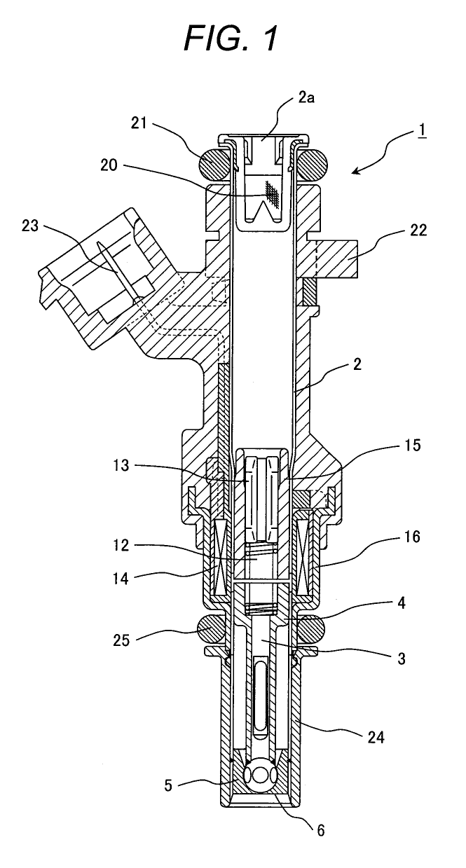

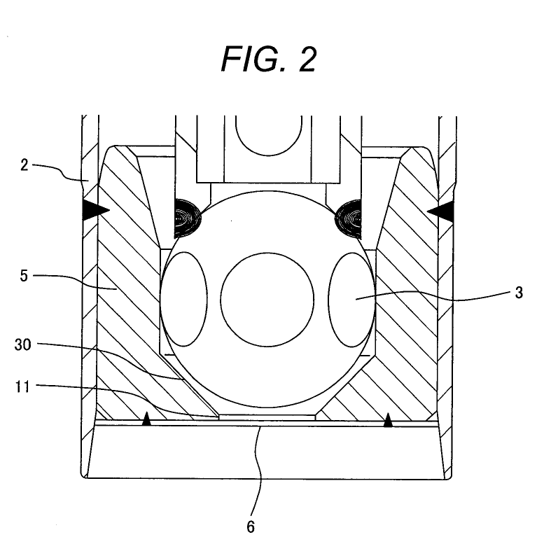

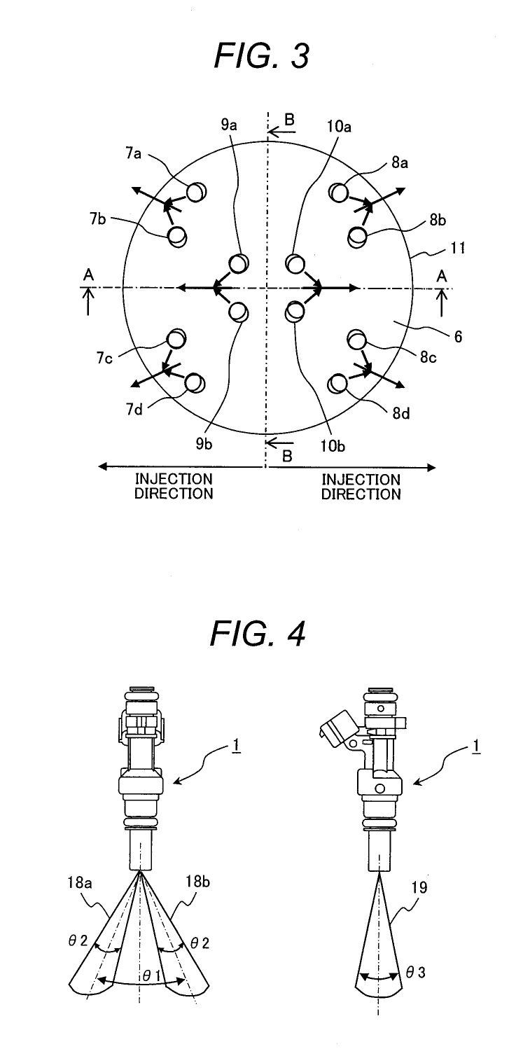

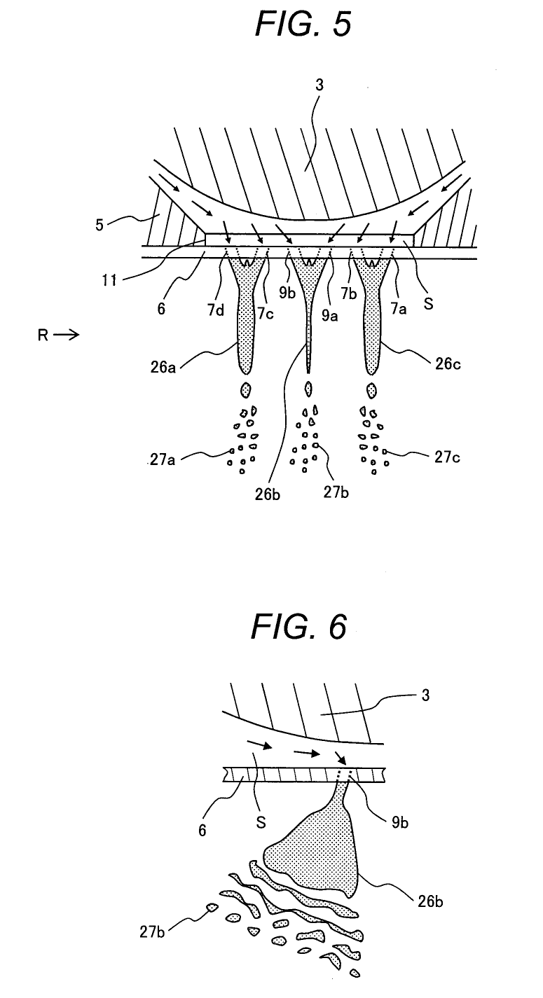

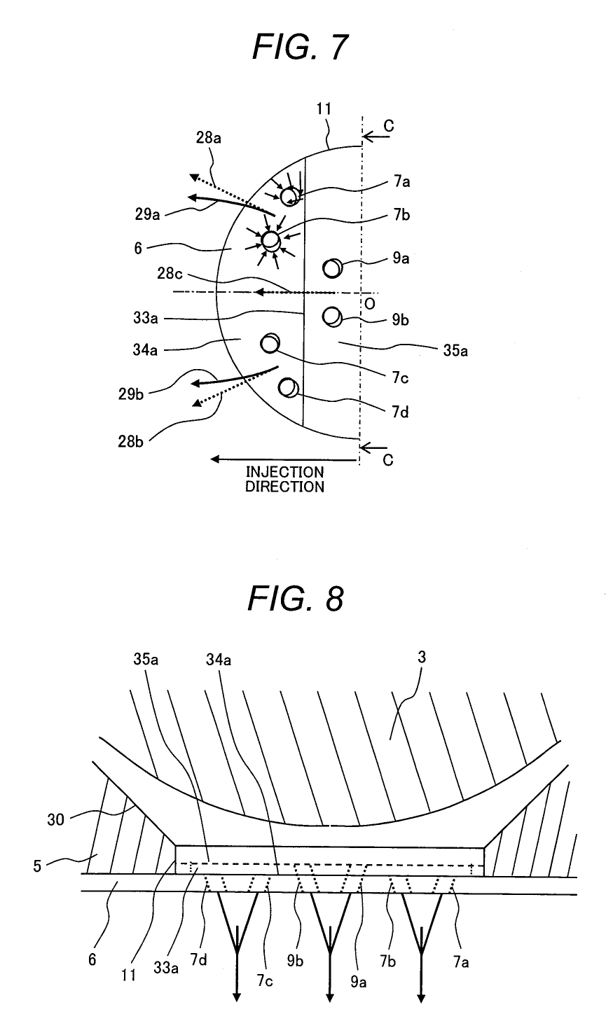

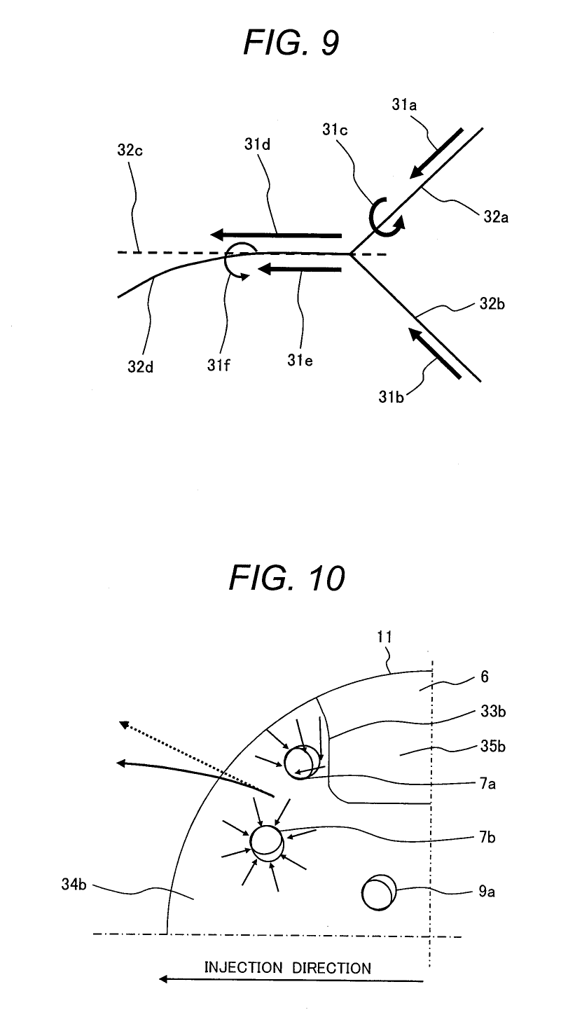

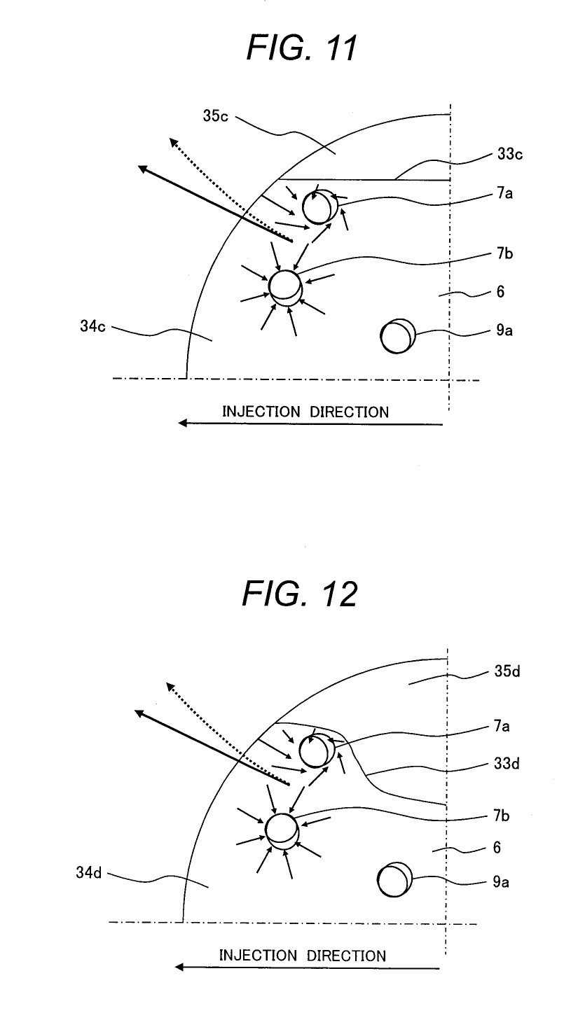

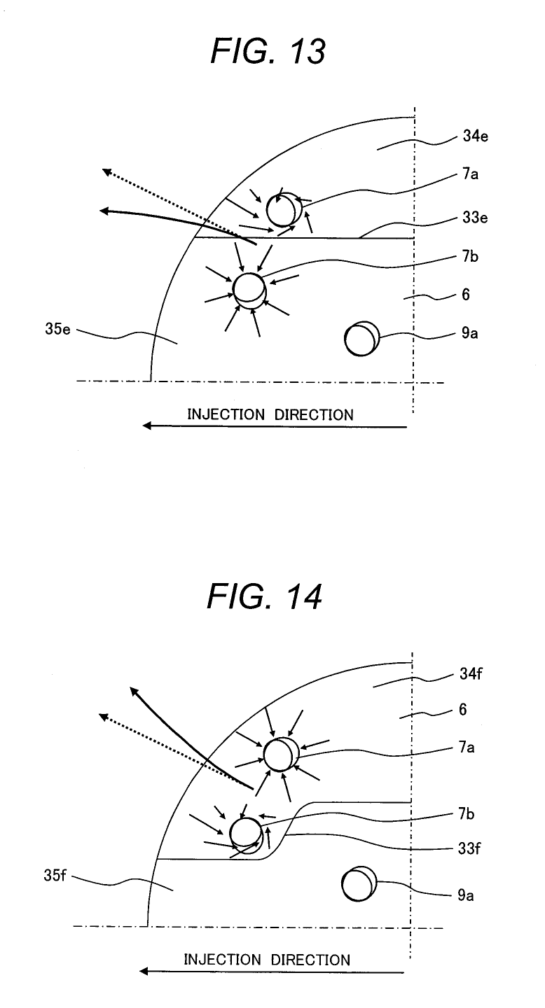

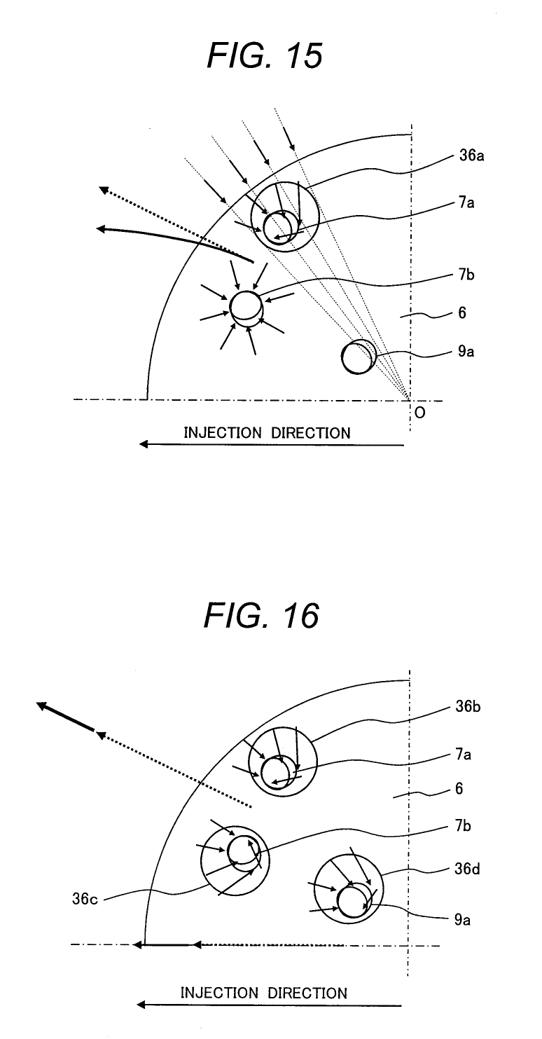

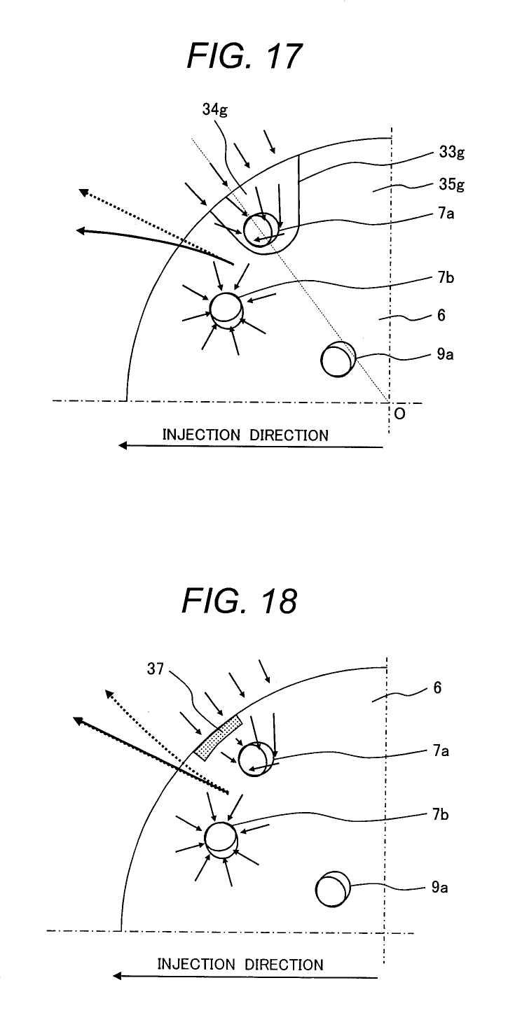

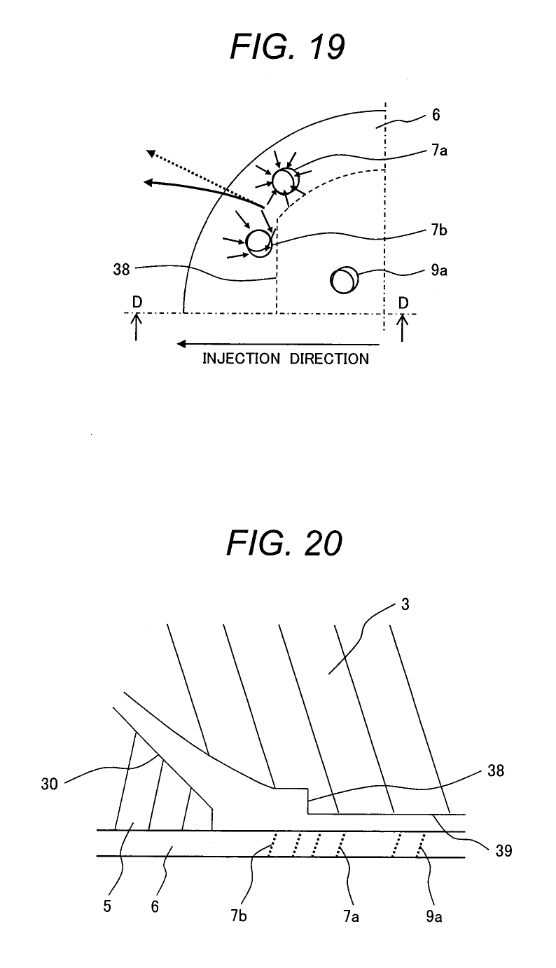

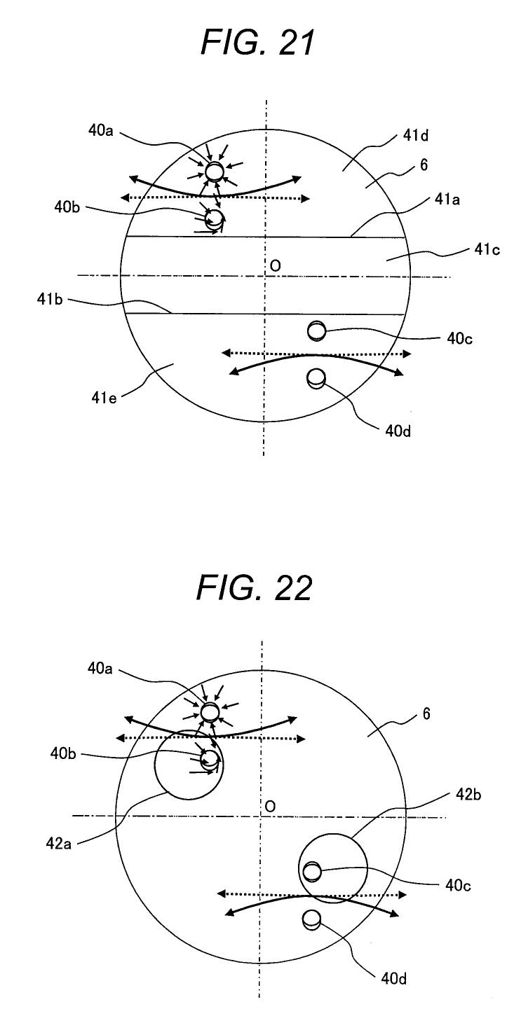

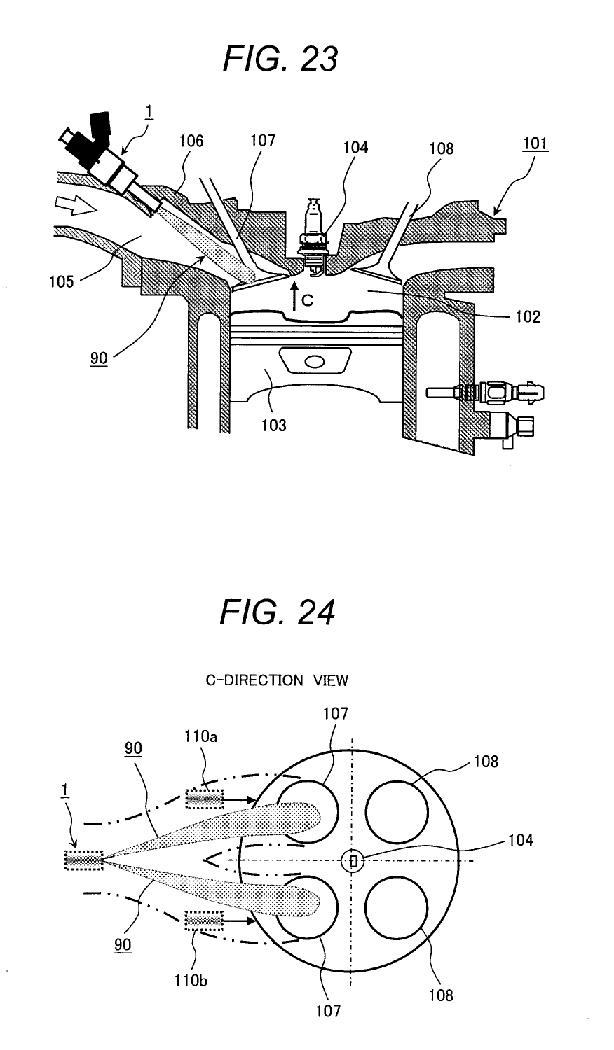

### BRIEF DESCRIPTION OF DRAWINGS

[FIG. 1] A longitudinal cross-sectional view showing the entire structure of a fuel injection valve as a subject of application of the present invention;

[FIG. 2] An enlarged cross-sectional view showing a part around a nozzle at around an end of the above-described fuel injection valve;

[FIG. 3] A plan view showing a part of a conventional nozzle plate incorporated in the above-described fuel injection valve and an arrangement status of fuel nozzle holes provided in the nozzle plate;

[FIG. 4] A diagram showing a definition of a spray cone angle used in the fuel injection valve;

[FIG. 5] A cross-sectional arrow diagram along a line B-B in FIG. 3 schematically showing a fuel flow and a spray pattern injected from a conventional fuel nozzle hole;

[FIG. 6] A cross-sectional arrow diagram along a line A-A in FIG. 3 showing a central spray in the fuel sprays in FIG. 5 viewed from a left side;

[FIG. 7] A plan view showing a part of a nozzle plate used in a fuel injection valve according to an embodiment 1 of the present invention and an arrangement status of fuel nozzle holes provided in the nozzle plate;

[FIG. 8] A partially-enlarged cross-sectional view schematically showing the flow of fuel in the vicinity of the fuel nozzle hole in the embodiment 1 and cross-sectional arrow diagram along a line C-C in FIG. 7;

[FIG. 9] An explanatory view showing axis-directional velocity component and swirl velocity components of fuel injected from a pair of nozzle holes in the embodiment 1 and a spray pattern variable mechanism;

[FIG. 10] A partial plan view showing the nozzle plate used in an embodiment 2 of the present invention and an arrangement status of a part of the fuel nozzle holes;

[FIG. 11] A partial plan view showing the nozzle plate used in an embodiment 3 of the present invention and an arrangement status of a part of the fuel nozzle holes;

[FIG. 12] A partial plan view showing the nozzle plate used in an embodiment 4 of the present invention and an arrangement status of a part of the fuel nozzle holes;

[FIG. 13] A partial plan view showing the nozzle plate used in an embodiment 5 of the present invention and an arrangement status of a part of the fuel nozzle holes;

[FIG. 14] A partial plan view showing the nozzle plate used in an embodiment 6 of the present invention and an arrangement status of a part of the fuel nozzle holes;

[FIG. 15] A partial plan view showing the nozzle plate used in an embodiment 7 of the present invention and an arrangement status of a part of the fuel nozzle holes;

[FIG. 16] A partial plan view showing the nozzle plate used in an embodiment 8 of the present invention and an arrangement status of a part of the fuel nozzle holes;

[FIG. 17] A partial plan view showing the nozzle plate used in an embodiment 9 of the present invention and an arrangement status of a part of the fuel nozzle holes;

[FIG. 18] A partial plan view showing the nozzle plate used in an embodiment 10 of the present invention and an arrangement status of a part of the fuel nozzle holes;

[FIG. 19] A partial plan view showing the nozzle plate used in an embodiment 11 of the present invention and an arrangement status of a part of the fuel nozzle holes;

[FIG. 20] A cross-sectional arrow diagram along a line D-D in FIG. 19 showing the nozzle plate used in the above-described embodiment 11 and a part upstream of the nozzle plate;

[FIG. 21] A partial plan view showing a part of the nozzle plate used in an embodiment 12 of the present invention and an arrangement status of the fuel nozzle holes;

[FIG. 22] A partial plan view showing a part of the nozzle plate used in an embodiment 13 of the present invention and an arrangement status of the fuel nozzle holes;

[FIG. 23] A longitudinal cross-sectional view of an internal combustion engine showing a status in which the fuel injection valve according to the above-described respective embodiments of the present invention is incorporated and a fuel spray status; and

[FIG. 24] A diagram of FIG. 23 viewed from a C-direction.

### DESCRIPTION OF EMBODIMENTS

Hereinbelow, examples of the present invention will be described based on embodiments.

### Embodiment 1

First, an embodiment 1 of the present invention will be described using FIG. 1 to FIG. 9.

FIG. 1 is a longitudinal cross-sectional view of a fuel injection valve applied to the embodiment 1 of the present invention, and FIG. 2 is a partially-enlarged longitudinal cross-sectional view showing a part around a nozzle of the fuel injection valve.

In FIG. 1, a fuel injection valve 1 supplies a fuel to an internal combustion engine for a vehicle such as an automobile. The fuel injection valve 1 is a multi-hole type injector, as described later, having multiple fuel nozzle holes. In the fuel injection valve 1, a movable valve element 3 is moved away from a valve seat 30 (see FIG. 2) upon energization of an electromagnetic coil to make valve-opening, and thereby the fuel can be injected through the multiple nozzle holes.

A casing 2 of the injection valve has a slim-shaped and thin-walled cylindrical body by press-working or cutting and partially drawing. The material of the casing 2 is ferrite stainless material mixed with flexible material such as titanium having a magnetic property.

One end side (top end side in FIG. 1) of the casing 2 is provided with a fuel supply port 2a, and the other end side is provided with a nozzle plate 6 having multiple nozzle holes, wherein the nozzle plate 6 is held with a nozzle body (nozzle holder) 5. As shown in FIG. 2, the nozzle plate 6 is fixed to an exit side end face of the nozzle body 5 via an arbitrary fixing means such as welding. Note that the fuel nozzle holes will be described after general description of the fuel injection valve.

The outside of the casing 2 is provided with an electromagnetic coil 14 and a yoke 16 of magnetic material surrounding the electromagnetic coil 14. A stationary-side core (hereinbelow, referred to as a “stationary core”) 15 is inserted and fixed around a member (drawn part) located at a midpoint position in an axial direction inside the casing 2. The stationary core 15 is positioned inside the electromagnetic coil 14.

In the casing 2, the valve element 3 incorporated so as to move linearly reciprocally at a predetermined stroke between the nozzle body 5 and the stationary core 15, wherein the valve element 3 is integrally formed with a movable core (hereinbelow, referred to as an “anchor”) 4. That is, an upper end of the anchor 4 and a lower end of the stationary core 15 are in opposition to each other, and in a status where a spherical portion (ball valve) at an end of the valve element 3 is seated on a valve seat 30, the upper end of anchor 4 is located so as to be opposite to the lower end of the stationary core 15 keeping a gap for the predetermined stroke.

The valve element 3 has a hollow rod shape except the ball valve at its end. The anchor 4 and the hollow rod are formed by injection-molding magnetic metal powder by the MIM (Metal Injection Molding) or the like. The inside of the hollow rod of the valve element 3, the stationary core 15 and the anchor 4 constitutes a fuel passage.

As shown in FIG. 2, the ball valve is used at the end of the valve element 3. As the ball valve, e.g., a steel ball for ball-bearing which is a JIS standard product is used. This ball is employed in the point of its high roundness and mirror finished surface which is preferable to improve seat characteristic, and low-cost mass productivity and the like. Further, the ball used in the valve element preferably has a diameter of about 3 to 4 mm. This size is determined for weight reduction such that the valve element functions as a movable element.

The nozzle body 5 is fixed to the inside of the casing 2 by appropriate fixing means such as welding.

The inside of the nozzle body 5 is provided with an inner circumferential surface for guiding an axial direction movement of the ball vale of the valve element 3 and a conical surface (tapered surface) including the valve seat 30 on which the ball valve of the valve element 3 is seated upon valve closing. A lower end of the tapered surface is provided with an outlet-side fuel through hole 11. The taper angle of the above-described tapered surface is about 90° (80° to 100°). This taper angle is an optimum angle (in which a grinding machine can be used to form the tapered surface in the best condition) to grind around the seat 30 and increase the roundness for the boll valve. Such a taper angel can maintain an exceedingly high seat characteristic for the valve element 3. Note that hardness of the nozzle body 5 with a tapered surface including the seat 30 is increased by quenching, and further, superfluous magnetism is removed by demagnetize processing. This valve element structure enables injection amount control without fuel leakage. Further, it is possible to provide a valve element structure having high cost performance.

A spring 12 as an elastic member is incorporated over the inside of the stationary core 15 to the inside of the anchor 4. The spring 12 applies a force to press the end of the valve element 3 against the nozzle body 5. The stationary core 15 is provided with a spring adjuster 13 to adjust the pressing force of the spring 12 to the valve element 3. Further, the fuel supply port 2a is provided with a filter 20 to remove foreign materials included in the fuel. Further, an O ring 21 is attached to the outer periphery of the fuel supply port 2a to seal supplied fuel.

A resin cover 22 is provided to cover the casing 2 and the yoke 16 by means of resin molding. The resin cover 22 has a connector 23 to supply electric power to the electromagnetic coil 14.

One end-side part of the fuel injection valve 1A is provided with a protector 24, which is a cylindrical member of e.g. resin material, and the one end of the protector 24 overhangs outward in a diameter direction from the casing 2. Further, an O-ring 25 is attached to one end-side part of an outer periphery of the casing 2. The O-ring 25 is arranged between the yoke 16 and the protector 24 to be prevented from dropping off, and for example, under a status where the one end-side part of the casing 2 is inserted into an injection valve-installation portion (not shown) provided on an intake pipe of the internal combustion engine, it seals a gap between the casing 2 and the injection valve-installation portion.

In the fuel injection valve 1, when the electromagnetic coil 14 as a valve drive actuator is in unenergized status, the end of the valve element 3 comes into contact with the seat 30 of the nozzle body 5 by the pressing force of the spring 12. In this status, the valve is in a valve-close status, and the fuel flowing from the fuel supply port 2a stays inside the casing 2.

When an electric current as an injection pulse is applied to the electromagnetic coil 14, a magnetic circuit is formed in the yoke 16, the core 15 and the anchor 4 which are made of magnetic material. The valve element 3 moves by the electromagnetic force of the electromagnetic coil 14 against the pressing force of the spring 12 until contacting with the lower end surface of the stationary core 15. In a status where the valve element 3 has moved to the stationary core 15-side, the valve is in the valve-open status, and a fuel passage is formed between the valve element 3 and the seat 30. The fuel in the casing 2 flows in the nozzle from the peripheral portion of the valve element 3, and then is injected from the fuel nozzle holes. The fuel injection amount is controlled by controlling timing of selection between the valve-open status and the valve-close status by moving the valve element 3 in the axial direction of the injection valve in correspondence with the injection pulse intermittently applied to the electromagnetic coil 14.

The nozzle plate 6 (shown in FIGS. 7 to 9) used in the present embodiment will be described in comparison with the conventional nozzle plate shown in FIG. 3.

As shown in an arrangement diagram of the conventional fuel nozzle holes in FIG. 3, the nozzle plate 6 is provide with multiple (e.g. the number of the holes is 12) fuel nozzle holes 7a, 7b, 7c, 7d, 8a, 8b, 8c, 8d, 9a, 9b, 10a and 10b formed through the plate. In these nozzle holes, a pair of fuel sprays to be collided with each other is formed by two holes to two holes. Combinations of pairs are outside holes 7a and 7b, 7c and 7d, 8a and 8b, 8c and 8d, inside holes 9a and 9b, and 10a and 10b. A circular nozzle plate region forming the fuel nozzle holes shown in FIG. 3 corresponds with a projected area of the fuel through holes 11 shown in FIG. 2. In FIG. 3, all the nozzle holes are used in co-operation with the counterparts of the respective pairs for formation of fuel sprays to be collided with each other. However, it may be arranged such that a part of the nozzle holes are used for formation of a fuel spray not to be collided with each other. Regarding each diameter of the respective fuel nozzle holes, when the diameter is small, it is necessary to increase the number of holes to maintain the amount of flow in the fuel injection valve 1, and the cost for hole-making is increased due to difficulty of processing. On the other hand, when the diameter is large, as the fuel is injected from large holes, the liquid film after collision of the fuel sprays becomes thick, and it becomes difficult to promote the formation of fine liquid droplets for the fuel spray. Accordingly, it is necessary to design the diameter of the fuel nozzle holes with a predetermined preferable size. In the present embodiment, the diameter is set about 100 to 200

FIG. 4 shows a definition of a spray angle of the fuel spray injected from the fuel injection valve. The fuel spray from the fuel injection valve shown on the left side of FIG. 4 indicates a status where the fuel spray injected from the fuel injection valve 1 is formed with two directional sprays 18a and 18b (viewed from an extension line of a line B-B in FIG. 3). The directionalities of the two directional sprays correspond to the two fuel injection directions shown in FIG. 3. The spray 18a is formed with the group of the nozzle holes 7a and 7b, 7c and 7d, and 9a and 9b in the left half nozzle plate region to the drawing sheet surface with reference to the line B-B in FIG. 3. The spray 18b is similarly formed with the group of the nozzle holes 8a and 8b, 8c and 8d, and 10a and 10b in the right half nozzle plate region to the drawing sheet surface. The fuel spray from the fuel injection valve shown on the right side of FIG. 4 is viewed from an extension line of a line A-A orthogonal to the line B-B in FIG. 3.

The spray angle of the two directional sprays is defined as follows (one example). That is, θ1 is defined as an angle formed between centers of the two sprays 18a and 18b, which is observed from a direction vertical to a plane including the two directions of the two fuel sprays 18a and 18b. θ2 is defined as a divergence angle of the respective sprays 18a and 18b, which is also observed from the direction vertical to the plane including the two directions of the two fuel sprays 18a and 18b. θ3 is defined as a divergence angle of a spray 19, which is observed from the right angle direction with respect to the above-mentioned plane. FIG. 4 shows two directional sprays, however, when only one direction spray is formed, the angle θ1 is not formed but the angles θ2 and θ3 are formed.

FIG. 5 schematically shows the flow of fuel in the vicinity of the fuel nozzle holes and spray pattern in the arrangement status (FIG. 3) of the conventional fuel nozzle holes (diagram observed from arrow diagram along a line B-B cross section in FIG. 3). The arrow in the figure indicates the flow direction of the fuel. The fuel passes through the flow passage formed between the valve element 3 and the conical (tapered) surface of the nozzle body 5 upon valve opening, then flows in space S on an upper surface of the nozzle plate 6, passes through the respective nozzle holes (7a, 7b, 7c, 7d, 9a and 9b), and injected in liquid column shape in external space. The liquid columns injected from the respective nozzle holes collide in the above-described respective pairs to form liquid films (26a, 26b and 26c). The liquid films further spread in the external space by fuel inertia, and when the liquid films spread up to some extent, the ends of them become break-up to form liquid droplets (27a, 27b ad 27c), thus fine atomization of fuel spray can be obtained.

FIG. 6 is a diagram showing the central spray 26b among the sprays in FIG. 5 observed from the left (arrow R direction). The figure corresponds with the diagram viewed in the A-A cross section in FIG. 3. The fuel liquid column injected from the nozzle hole 9b collides with a liquid column injected from the nozzle hole 9a in the behind side (not shown) to form the liquid film 26b. The liquid film further spreads in the space, and when it spreads up to some extent, its end becomes break-up in thread-like shape pieces, and the thread-like liquid film pieces further becomes break-up in fine pieces, thus liquid droplets 27b are formed.

FIG. 7 shows an arrangement of fuel nozzle holes according to the embodiment 1 of the present invention. FIG. 7 shows a left half of a region corresponding with the projection area of the fuel through holes 11 of the nozzle plate 6. Although the arrangement of fuel nozzle holes in the right half region is omitted in the figure, it is symmetric with respect to the left half region. The arrangement of the fuel nozzle holes corresponds with the conventional arrangement in FIG. 3.

In the present embodiment, a step height 33a is provided on the top surface of the nozzle plate 6, accordingly, planes having a difference in height is formed in the top surface of the nozzle plate, in which a higher (upper step side) surface is referred to as a projection portion 35a, and a lower (lower step side) surface is referred to as a depression portion 34a.

As shown in FIG. 7, the projection portion 35a is configured by a region formed on the nozzle plate 6, which is surrounded with two arc lines along a projection contour (circle) of the fuel through holes 11 of the nozzle body 5 and two parallel straight lines along a diameter direction of the nozzle plate 6, and formed around the center in the nozzle plate 6. The depression portion 34a is formed on a left side and a right side across the projection portion 35a (FIG. 7 shows only the left side).

As described in FIG. 3, in the half region of the nozzle plate, the nozzle holes 7a and 7b, the nozzle holes 7c and 7d, and the nozzle holes 9a and 9b are respectively in pairs. In the present embodiment, a pair of nozzle holes 9a and 9b is formed in the projection portion 35a, and a pair of nozzle holes 7a and 7b and a pair of nozzle holes 7c and 7d are formed in one side (left side) depression portion 34a. Note that although not shown in FIG. 4, in the other half region of the nozzle plate, the nozzle holes 8a and 8b, the nozzle holes 8c and 8d, and the nozzle holes 10a and 10b are respectively in pairs (as in the case of FIG. 3). In the present embodiment, a pair of nozzle holes 10a and 10b is formed in the region of the projection portion 35a, and a pair of the nozzle holes 8a and 8b and a pair of the nozzle holes 8c and 8d are formed in the other side (right side) depression portion 34a.

FIG. 8 shows a cross-sectional arrow diagram along a line C-C in FIG. 7, showing the nozzle plate 6, the valve element 3 and a part of the nozzle body 5. Note that for the sake of drawing, the projection portion 35a is represented with a broken line in place of a solid line. As already described, in the figure, the nozzle holes 7a and 7b, the nozzle holes 7c and 7d, and the nozzle holes 9a and 9c are respectively in pairs.

In FIG. 7, regarding the nozzle holes 7a and 7b, directions of fuel flowing into the inlets of the two nozzle holes are indicated with arrows representing the respective nozzle holes. The directions of the fuel flowing to the top surface of the nozzle plate are centripetal directions toward the center O of the nozzle plate. Accordingly, in the nozzle hole 7a, as the step height 33a is placed in the vicinity of the nozzle hole, a part of the fuel flowing in the above-described centripetal direction is changed to a direction along the wall of the step height. As a result, a fuel flow velocity distribution is produced at the inlet of the nozzle hole and thereby a swirl flow is formed in the nozzle hole 7a. On the other hand, as the nozzle hole 7b is away from the step height 33a relatively, the fuel flow velocity distribution at the inlet of the nozzle hole is not influenced by the step height, and a uniform inflow without swirl i.e. an inflow mainly having a nozzle hole axis-directional velocity component is formed. Regarding the other pair of nozzle holes, the nozzle holes 7c and 7d, a swirl flow is formed in the nozzle hole 7d near the step height by the same principle. On the other hand, in the pair of nozzle holes 9a and 9b, as the inlets of the nozzle holes are positioned on the projection portion 35a, the inflow of the fuel thereto is not influenced by the step height, and a uniform inflow without swirl flow is formed.

In the present embodiment shown in FIGS. 3 and 7, when the fuel pressure is changed, the nozzle hole axis-directional velocity component of the fuel flowing into the respective nozzle holes is changed by approximately ½ power of the fuel pressure. In the arrangement of the conventional fuel nozzle holes (FIG. 3), even when the fuel pressure is changed, the change rate of the fuel nozzle hole axis-directional velocity component is the same in all the nozzle holes; and further, as the forces of collision of fuel liquid columns injected from each pair of nozzle holes are equal. Therefore, in the conventional fuel nozzle hole, the direction of the formed liquid film does not deflect. On the other hand, in the present embodiment, in the nozzle holes 7a and 7b near the step height, as the swirl flow formed at the inlet of the nozzle hole is changed in accordance with change of fuel pressure, at the inlet of nozzle hole, the fuel with a composite velocity component of the nozzle hole axis-directional velocity component and the swirl velocity component flows into the nozzle hole, and the kinetic energy of the injected fuel liquid column is a different intensity from the kinetic energy of the counterpart fuel liquid column of the pair. As a result, the collision energies of the two fuel liquid columns injected from a pair of nozzle holes are different from each other. For example, in accordance with increase in fuel pressure, the liquid film shape formed after the collision of the fuel liquid columns injected from the nozzle holes 7a and 7b changes from a dotted-line arrow 28a to a solid-line arrow 29a direction in FIG. 7. Similarly, the liquid film shape of the fuel liquid columns injected from the nozzle holes 7c and 7d changes from a dotted-line arrow 28b to a solid-line arrow 29b in FIG. 7.

Regarding the nozzle holes 9a and 9b on the projection portion 35a, even when the fuel pressure is changed, as the both flows mainly have the nozzle hole axis-directional velocity component and the same ratio, the collision energies of the fuel liquid columns injected from the both nozzle holes are the same together. The directionality of the fuel spray liquid film shaped after the collision does not deflect and keeps in the same status as indicated with a dotted-line arrow 28c.

The change amount (including the directionality) of the liquid film shape can be controlled by changing the distance between the step height 33a and each nozzle hole. As shown in FIG. 7, the pair of liquid film shapes can be changed to liquid films 29a and 29b indicated with solid-line arrows including the directionalities in accordance with increase in fuel pressure, the spray angle θ3 in FIG. 4 is mainly changed. In FIG. 7, the spray angle θ3 is reduced in accordance with increase in fuel pressure. Accordingly, upon cold engine starting operation, the fuel pressure is reduced so as to widen the spray angle θ3 and enlarge the spray surface area to promote natural evaporation. While upon engine warming up, the fuel pressure is increased so as to narrower the spray angle θ3 and bring the spray to collide with the intake valve as target to cause evaporation by incoming heat from the intake valve. Thus it is possible to improve exhaust performance and output performance.

Further, in addition to the changing of fuel pressure, when the stroke of valve element is changed, the amount of fuel inflow into the nozzle hole is changed. As a result, it is possible to make a swirl velocity component as well as in the case of changing the fuel pressure. Regarding the valve element stroke, it is possible to perform stepless variable stroke control using a piezo device in place of the electromagnetic coil as a driving source. In use of the electromagnetic coil (solenoid), it is possible to perform two-stage variable stroke control with two driving circuits.

Further, regarding the step height 33a, the height H is equal to or higher than ( 1/10)R with respect to a radius of each nozzle hole. Further, for the step height 33a to exert an influence upon the swirl forces at the nozzle holes 7a and 7d, it is necessary to set a distance between the step height and the nozzle holes (i.e. the shortest distance between the step height and the pair of nozzle holes) to 3R or shorter. Because the velocity distribution of the fuel flowing into each nozzle hole depends on an area (A) of the fuel through hole on the upstream of inlets of the nozzle holes in contact with the inlets of the nozzle holes, i.e., the velocity distribution is proportional to 2nd power of the radius R of the nozzle hole. As a velocity of the flow flowing into each nozzle hole is inversely proportional to the above-described the area (A) of the fuel through hole, the step height does not influence the fuel flow velocity distribution at the inlet of the nozzle hole on the condition that the above-described area (A) of the through hole is equal to or greater than 10 times of an area (Ao) of the nozzle hole. Accordingly, on the condition that a radius of the through hole is equal to or greater than about 3.3 times of the radius of the nozzle hole, the step height does not influence the fuel flow velocity distribution at the inlet of the nozzle hole. According to this calculation, to form a swirl velocity component with the step height, it is necessary to set the above-described shortest distance between the step height and the pair of nozzle holes to 3R or shorter. Further, on the condition that the step height is in the same order of the nozzle hole size, the step height is effective only for formation of swirl velocity in the nozzle hole. When the step height is ( 1/10) R of the radius of the nozzle hole, the distribution ratio is 1-order smaller, and invalid in the swirl velocity formation. Accordingly, the lower limit of the step height is ( 1/10)R.

FIG. 9 shows a spray pattern variable mechanism according to the embodiment 1 of the present invention. In the figure, arrows 31a and 31b indicate axial direction velocity components of fuel liquid columns injected from a pair of nozzle holes, and an arrow 31c indicates a swirl velocity component produced with the above-described step height. The fuel liquid columns injected from the pair of nozzle holes collide with each other and thereby form a liquid film. There is produced a velocity difference between a velocity 31d in a liquid film corresponding to the kinetic energy of the fuel liquid column on the upper side in FIG. 9 (corresponding to the nozzle hole 7a or 7d on the near side of the step height in FIG. 7) and a velocity 31e in the liquid film corresponding to the kinetic energy of the fuel liquid column on the lower side (corresponding to the nozzle hole 7b or 7c on the side away from the step height in FIG. 7). As a result, a flow from a high velocity region toward a low velocity region is formed in the liquid film, then the direction of the liquid film is deflected, namely the liquid film can be deflected from a form indicated with a dotted line 32c to a form indicated with a solid line 32d. In this arrangement, the spray pattern after break-up of the liquid film can be changed.

Note that in the nozzle plate 6 of the present embodiment, the depression portion 34a, which is a region facing a lower end of the tapered surface of the nozzle body 5, i.e., a region facing the fuel through hole 11, is formed by a flat surface continuously together with a region of the outside of the depression portion as shown in FIG. 8. However, the surface is not limited to such flat shape surface. It may be arranged such that the region facing the fuel through hole 11 is extruded toward a lower side than the outside region thereof by punching or the like while keeping the status where the step height formed with the depression portion 34a and the projection portion 35a is maintained on the top surface of the plate, and thereby the region facing the fuel through hole 11 is lowered than the outside region thereof. In order to such a lowered region facing the fuel through hole, the extruding therefore is performed by punching in a manufacturing process of forming the projection portion 35a. Regarding a punch for the extruding, it is preferable to use the punch having a diameter of 6 to 9 mm to obtain a shape matching with the valve element 3.

### Embodiment 2

In the nozzle plate 6, regarding the forms of the step height provided on the top surface of the region facing the fuel through hole 11 and the depression portion formed with the step height, they are not limited to those in the embodiment 1, but various forms may be proposed as follows.

FIG. 10 shows another example (embodiment 2) of those forms. Since the structure of the fuel injection valve is the same as that of the embodiment 1 except the nozzle plate, illustration and explanations of parts other than the nozzle plate will be omitted (note that, as the structures in the embodiments in FIG. 11 and the subsequent figures are the same as that of the embodiment 1 except the nozzle plate, illustration and explanations of parts other than the nozzle plate will be omitted).

In the present embodiment, as shown in FIG. 10, a step height 33b is formed only in the vicinity of the nozzle hole 7a (although illustration is omitted, regarding the nozzle hole 7d, the step height is similarly formed). FIG. 10, indicating the ¼ region of the region at the lower end of the taper surface of the nozzle body in the nozzle plate facing the fuel through hole 11, shows only the step height 33b in the vicinity of the nozzle hole 7a, however, a similar step height is provided in the vicinity of the nozzle hole 7d. Accordingly, a projection portion 35b and a depression portion 34b are formed on the top surface of the nozzle plate. The height H of the step height 33b and the distance relation between the step height and the nozzle hole is the same as those in the embodiment 1 (note that in the embodiments in FIG. 11 and the subsequent figures, the height and the distance relation are the same).

In the present embodiment, a swirl force in the same direction as that in the embodiment in FIG. 7 is formed at the nozzle hole 7a. As a result, in the pair of nozzle holes 7a and 7b (although not shown, also in the nozzle holes 7c and 7d), a difference of the swirl forces is produced between the both nozzle holes, and the liquid film is deflected from a dotted-line arrow to a solid-line arrow in the figure by increase of the fuel pressure. In the present embodiment, as the step height 33b has a curved surface, a swirl force can be easily formed, and a stronger swirl force can be formed in comparison with that of the embodiment in FIG. 7. Further, as the pair of nozzle holes (9a and not shown nozzle hole 9b) at a center side of the nozzle plate are provided not in the projection portion but in the depression portion 34b, the thickness of the nozzle plate can be reduced compared with that of the embodiment shown in FIG. 7, and it is possible to facilitate making the nozzle holes.

### Embodiment 3

Next, description will be done as to the form of the nozzle plate 6 in an embodiment 3 using FIG. 11.

In the present embodiment, as shown in FIG. 11, a step height 33c is provided in the vicinity of the nozzle hole 7a (although illustration is omitted, the step height is similarly provided regarding the nozzle hole 7d) so as to have a direction different from that of the embodiment 1 (e.g., the direction is different at 90 degree from that of the embodiment 1) in a region out of the center of the nozzle plate. Also in the present embodiment, a projection portion 35c and a depression portion 34c are provided on a top surface of the nozzle plate by forming a step height 33c. The projection portion 35c is configured with a region surrounded with an arc line and a straight line, and a region of the depression portion 34c is formed inside of the projection. All the nozzle holes are arranged on the side of the depression portion 34c.

In the present embodiment, a swirl force is formed at the nozzle hole 7a in a direction opposite to that of the embodiment 1 in FIG. 7. In the present embodiment, in the nozzle hole 7a, as a part near the step height 33c is in a position where the fuel flowing into the nozzle hole 7a is regulated (the flow velocity is reduced), when the fuel pressure is in a low state and thereby the swirl velocity component is reduced, the nozzle hole axis-directional velocity component is increased, and the kinetic energy of the fuel flowing into the nozzle hole 7b is larger than that of the fuel flowing into the nozzle hole 7a. As a result, the fuel liquid film is deflected from a solid line to a dotted-line arrow. Contrarily, when the fuel pressure increases, a difference of swirl forces is increased between the pair of nozzle holes 7a and 7b (the swirl force at the nozzle hole 7b becomes larger), and the liquid film is deflected from the dotted-line arrow toward the solid-line arrow in the figure. In the present embodiment as well as the embodiment 2, as the inside pair of nozzle holes (9a and not shown nozzle hole 9b) are provided in the depression portion 34c side, the thickness of the nozzle plate can be reduced compared with that of the embodiment shown in FIG. 7, and it is possible to facilitate making the nozzle holes.

### Embodiment 4

Next, description will be done as to the form of the nozzle plate 6 of an embodiment 4 using FIG. 12.

In FIG. 12, a step height 33d is provided in a region out of the center of the nozzle plate so as to have a direction different from that of the embodiment 1 as well as the embodiment in FIG. 11. A shape of the step height 33d has an S-shaped curve around the nozzle hole 7a following a part of the nozzle hole 7a. In the top surface of the nozzle plate, a projection portion 35d and a depression portion 34d are formed with the step height 33d.

All the nozzle holes are provided in the depression portion 34d side.

In the present embodiment as well as the embodiment 3, a swirl force is formed at the nozzle hole 7a in a direction opposite to that of the embodiment 1. In the present embodiment as well as the embodiment 3, in the nozzle hole 7a, as a part near the step height 33d is in a position where fuel flowing into the nozzle hole 7a is regulated (the flow velocity is reduced), when the fuel pressure is in a low state and thereby the swirl velocity component is reduced, the nozzle hole axis-directional velocity component is increased, and the kinetic energy of the fuel flowing into the nozzle hole 7b is larger than that of the fuel flowing into the nozzle hole 7a.

As a result, the fuel liquid film is deflected to a dotted-line arrow in the figure. Contrarily, when the fuel pressure increases, a difference of swirl forces is increased between the pair of nozzle holes 7a and 7b (the swirl force at the nozzle hole 7b becomes larger), and the liquid film is deflected from the dotted-line arrow toward a solid-line arrow in the figure. In the present embodiment, as the step height 33d has a curved surface, the swirl component can be easily formed, and a stronger swirl force can be formed in comparison with that of the embodiment in FIG. 11.

### Embodiment 5

Next, description will be done as to the form of the nozzle plate 6 in an embodiment 5 using FIG. 13.

In the present embodiment, a step height 33e is formed with two parallel lines (illustration of the other step height with the parallel lines is omitted) so as to have a direction different from that of FIG. 7 by 90 degree (including more or less 90-degree), a projection portion 35e is formed in a central region, and a depression portion 34e is formed outside at both sides of the projection portion 35e. The nozzle hole 7a (and the not shown nozzle hole 7b) is provided in the vicinity of the step height 33e of the depression portion 34e. The other nozzle holes are provided in the projection portion 35e.

In the present embodiment as well as the above-described embodiments, a difference of swirl forces is produced between the pair of nozzle holes 7a and 7b (also between the not shown nozzle holes 7c and 7d) by increase of the fuel pressure, and the liquid film is deflected from a dotted-line arrow to a solid-line arrow in the figure.

### Embodiment 6

Next, description will be done as to the form of the nozzle plate 6 in an embodiment 6 using FIG. 14.

In the present embodiment, a step height 33f is formed in a central region so as to have a direction different from that of FIG. 7, and a depression portion 34f is formed outside the projection portion at both sides of the projection portion 35f. The nozzle holes 7a and 7b (and the not shown nozzle holes 7c and 7d) are provided in the depression portion 34f side, and the nozzle hole 9a (and the not shown nozzle hole 9b) is provided in the projection portion 35f side.

In the present embodiment, which is different from the above-described embodiments, the step height 33f is formed in the vicinity of the nozzle hole 7b and the not shown nozzle hole 7c. Further, a shape of the step height 33f has an S-shaped curve around the nozzle hole 7b (7c) along a part of the nozzle hole 7b (7c).

In the present embodiment, a difference of swirl forces is produced between the pair of nozzle holes 7a and 7b (and 7c and 7d), and the liquid film is deflected from a dotted-line arrow to a solid-line arrow in the figure by increase of the fuel pressure.

### Embodiment 7

Next, description will be done as to the form of the nozzle plate 6 of an embodiment 7 using FIG. 15.

In the present embodiment, instead of the step height provided on the nozzle plate in the above-described embodiments, in the pair of nozzle holes 7a and 7b (and in the not shown nozzle holes 7c and 7d), a countersunk-like hole portion 36a is provided at an inlet of the one nozzle hole 7a (7d).

The countersunk-like hole portion 36a is provided at a position where a countersunk center is offset with respect to a line connecting between a center (o) of the nozzle plate and a center of the inlet of the nozzle hole 7a (7d). Accordingly, when the fuel flowing in a centripetal direction of the nozzle plate on the top surface of the nozzle plate upper flows into the countersunk-like hole portion, a swirl velocity component as indicated with an arrow is produced at the inlet of the nozzle hole 7a. With this effect, the fuel liquid film formed with the pair of nozzle holes 7a and 7b (and the not shown nozzle holes 7c and 7d) is deflected from a dotted-line arrow to a solid-line arrow in the figure by increase of the fuel pressure. The countersunk-like hole portion 36a provided in the present embodiment may be a conical shape or a cylindrical shape with a flat bottom. Further, the shape of the countersunk-like hole portion is not necessary to be a circle shape but may be a oval or approximate circle shape. In the present invention, it is possible to form the countersunk-like hole portion and the nozzle holes by punching through the nozzle plate using the same pin and therefore perform low-cost manufacturing. A radius of the countersunk-like hole portion is equal to or smaller than 3R with respect to a radius R of the nozzle hole. A depth of the countersunk-like hole portion must be equal to or larger than ( 1/10)R. The velocity distribution of the fuel flowing into the nozzle hole depends on an area of the fuel through hole provided on the upstream side of the inlet of the nozzle hole, i.e., the velocity distribution is proportional to the 2nd power of the nozzle hole radius R. As the fuel inflow velocity into the nozzle hole is inversely proportional to the above-described the area (A) of the fuel through hole, the countersunk-like hole portion does not influence the fuel flow velocity distribution at the inlet of the nozzle hole on the condition that the above-described the area of the fuel thorough hole is equal to or greater than 10 times of an area of the nozzle hole. Accordingly, on the condition that a radius of the countersunk-like hole portion is about 3.3 times of the nozzle hole diameter, the countersunk-like hole portion does not influence the fuel flow velocity distribution at the inlet of the nozzle hole. According to this calculation, to produce a swirl velocity component with the countersunk-like hole portion, it is necessary to set the radius of the countersunk-like hole portion to equal to or shorter than 3R with respect to the nozzle hole radius R. Further, the depth of the countersunk-like hole portion contributes to the direction of fuel flowing into the nozzle hole. When the depth is equal to or less than 1/10 of the nozzle hole radius, the contribution to the inflow velocity change can be ignored. From this calculation, the above-described depth of the countersunk-like hole portion must be equal to or greater than 1/10 of the nozzle hole radius. Further, the upper limit of the depth is limited with the plate thickness of the nozzle plate and processing cost.

### Embodiment 8

Next, description will be described as to the form of the nozzle plate 6 in an embodiment 7 using FIG. 16.

In the present embodiment, countersunk-like hole portions 36b, 36c and 36d are provided at the inlets of all the nozzle holes. Each countersunk-like hole portion is provided such that a center of the countersunk-like hole portion is in a position offset with respect to a line connecting between the center (O) of the nozzle plate and a center of each nozzle hole. Accordingly, when the fuel flowing in a centripetal direction of the nozzle plate on the top surface of the nozzle plate flows into the countersunk-like hole portion, a swirl velocity components indicated with arrows is produced at the inlets of the nozzle hole 7a, 7b and 9a. In FIG. 17, as the offset amounts of the countersunk-like hole portions provided in a pair of nozzle holes are the same (the swirl directions are opposed to each other), even when the fuel pressure increases, the liquid film obtained by collision of the liquid columns is not deflected, and the liquid film spreads in addition to a dotted-line arrow, toward a solid-line arrow, in the figure. This varies the both spray angles θ2 and θ3. Further, in the present embodiment, it is possible to deflect the liquid film by making the offset amounts of countersunk-like hole portions, the radius of countersunk-like hole portions, the depths of countersunk-like hole portions, the contour shapes of sunk-like hole portions and/or the like different from each other at the respective pair of the nozzle holes. Further, it is possible to obtain various fuel spray shapes by allotting the effect of changing the above-described spray angles θ2 and θ3 and the effect of the spray angle θ3 in the embodiments 1 to 6 so as to vary from a pair of nozzle holes to a pair of nozzle holes.

### Embodiment 9

Next, description will be done as to the form of the nozzle plate 6 in an embodiment 9 using FIG. 17.

In the present embodiment, regarding the pair of nozzle holes 7a and 7b (also in the not shown nozzle holes 7c and 7d), a depression portion 34g is provided at the periphery of one nozzle hole 7a (7d), and a step height 33g is formed by a edge of the depression portion 34g. Thus, a projection portion 35g and the depression portion 34g are formed in the top surface of the nozzle plate.

The nozzle hole 7a (7d) is provided in the depression portion 34g, and other nozzle holes are provided in the projection portion 35g. As shown in FIG. 17, the depression portion 34g is asymmetrically provided with respect to a line connecting between the center (O) of nozzle plate and the center of the nozzle hole 7a (7d). With this arrangement, the fuel flows on the top surface of the nozzle plate in a centripetal direction of the nozzle plate, and then, upon inflow into the nozzle hole 7a (7d) from the depression portion 34g, a swirl velocity component is produced at the inlet of the nozzle hole as indicated with arrows. Thus, it is possible to deflect the liquid film shape from a dotted-line arrow to a solid-line arrow in the figure by increase of the fuel pressure.

### Embodiment 10

Next, description will be done as to the form of the nozzle plate 6 in an embodiment 10 using FIG. 18.

In the present embodiment, in the pair of nozzle holes 7a and 7b (also in the not shown nozzle holes 7c and 7d), a projection 37 is provided near either nozzle hole 7a or 7d. Accordingly, apart of the fuel flowing in a centripetal direction of the nozzle plate on the top surface of the nozzle plate is blocked with the projection 37. As a result, a swirl velocity component is produced in the fuel at the entrance of the nozzle hole 7a as indicated with arrows. With this arrangement, it is possible to deflect the liquid film shape from a dotted-line arrow to a solid-line arrow in the figure by increase of the fuel pressure. The height H of the projection must be equal to or greater than 1/10 of the radius R of the nozzle hole. The height of the projection plays a role of contributing the directional change of the fuel flowing into the nozzle hole, however, the contribution to the inflow velocity change can be ignored when the height is 1/10 or less than the nozzle hole radius. From this calculation, the height of the projection must be equal to or greater than 1/10 of the nozzle hole radius. Further, the upper limit of the height depends on the processing cost and space size formed with the nozzle plate and the valve element.

### Embodiment 11

Next, description will be done as to the form of the nozzle plate 6 and the form of the valve element 3 in an embodiment 11 using FIG. 19.

In the present embodiment, the form of the nozzle plate 6 and the arrangement of the nozzle holes are the same as those of the conventional art shown in FIG. 3. On the other hand, regarding a valve element 3, as shown in FIG. 20, the end is flat-processed, and a step height 38 is formed at a peripheral region of the flat surface 39. The contour of the step height 38 is formed with two parallel straight lines and two arc lines. The step height 38 is placed close to the nozzle hole 7b (7c) such that one of the pair of nozzle holes 7a and 7b (also the not shown nozzle holes 7c and 7d), i.e., the nozzle hole 7b (7c) side in the present embodiment, is influenced by the step height 38.

According to the present embodiment, when the stroke amount of the valve element is small, as the step height 38 is closer to the inlet of the nozzle hole 7b (7c), a swirl velocity component as indicated with arrows is produced at the inlet of the nozzle hole 7b (7c). Accordingly, when the stroke amount of the valve element is small, it is possible to deflect the liquid film formed with a pair of nozzle holes from a dotted-line arrow to a solid-line arrow in the figure by increase of the fuel pressure.

According to the present embodiment, it is possible to change the liquid film shape including the directionality by changing the valve element stroke amount in correspondence with engine status.

### Embodiment 12

Next, description will be done as to the nozzle plate 6 in an embodiment 12 using FIG. 21.

In the present embodiment, as shown in FIG. 21, the arrangement of the fuel nozzle holes is to form a fuel spray injected in one direction wherein, when using the definition of the spray angles in FIG. 4, the spray has only the angles θ2 and θ3 but does not have the angle θ1. For example, the embodiment use four nozzle holes, and one pair of nozzle holes 40a and 40b, and another pair of nozzle holes 40c and 40d are symmetrically arranged on a diagonal line with reference to the center (O) of the nozzle plate. Two step height 41a and 41b are arranged in parallel, in the two, the step height 41a is positioned in the vicinity of the nozzle hole 40b, and the step height 41b is positioned in the vicinity of the nozzle hole 40c.

That is, as the step heights 41a and 41b are provided on the top surface of the nozzle plate, a projection portion 41c is formed in a central region, and the two depression portions 41d and 41e are formed on the both sides of the projection portion. On the depression portion 41d side, the nozzle holes 40a and 40b are arranged, while the nozzle holes 40c and 40d are arranged on the depression portion 41e side.

The fuel liquid columns injected from two nozzle holes of each pair collide with each other to form a liquid film. In this case, ones of the pairs of nozzle holes, the nozzle holes 40b and 40c near step heights 41a and 41b are influenced by these step heights. More particularly, in the nozzle hole 40b (40c), as a part near the step height 41a (41b) is in a position where the fuel flowing into the nozzle hole 40b (40c) is regulated (the flow velocity is reduced), when the fuel pressure is in a low state and thereby the swirl velocity component is reduced, the nozzle hole axis-directional velocity component is increased, and the kinetic energy of the fuel flowing into the nozzle hole 40a (40d) is larger than that of the fuel flowing into the nozzle hole 40b (40c). As a result, the fuel liquid film is deflected from a solid line to a dotted-line arrow in the figure. Then, when the fuel pressure increases, the difference of swirl force between the pair of nozzle hole 40b (40c) and nozzle hole 40a (40d) is increased (the force in the former nozzle hole is memorably increased. The latter is approximately the axis-directional velocity component). The liquid film is moved from the dotted-line arrow to the solid-line arrow in the figure.

According to the nozzle plate in the present embodiment, it forms one-directional fuel spray, the liquid column injected from an nozzle hole is injected in a vertically-downward direction with respect to the nozzle plate. Accordingly, the angle of collision upon formation of collision liquid film can be wider than the case of two-directional sprays. As a result, the collision force is increased and the liquid film is thinned, and better fine atomization of the fuel spray can be obtained in comparison with the two-directional sprays.

### Embodiment 13

Next, description will be done as to the nozzle plate 6 in an embodiment 13 using FIG. 22.

In the present embodiment as well as the embodiment 12, the arrangement of the fuel nozzle holes is to form a fuel spray injected in one direction wherein, when using the definition of the spray angles in FIG. 4, the spray has only the angle θ2 and θ3 but does not have the angle θ1.

In the present embodiment, in place of the step heights 41a and 41b in the embodiment 12, countersunk-like hole portions 42a and 42b are provided in one nozzle holes 40b and 40c in the respective pairs of nozzle holes 40a and 40b (40c and 40d). The center of the countersunk-like hole portion is offset with respect to a line connecting between the center (O) of the nozzle plate and the center of the nozzle hole 40b (40c). This offset effect makes fuel flow regulation as in the case of the embodiment 12. Upon fuel inflow in the countersunk-like hole portion, a swirl velocity component is produced, and as a result, a difference of swirl forces is produced between each pair of nozzle holes. The shape of the collision liquid film is deflect from a dotted-line arrow to a solid-line arrow by increase of the fuel pressure.

### Embodiment 14

FIG. 23 is a cross-sectional view when the fuel injection valve for two-directional fuel sprays in the above-described embodiments is incorporated in an internal combustion engine, and FIG. 24 is diagram of FIG. 23 viewed from a C-direction.

An internal combustion engine 101 has an intake port 106 to which a fuel injection valve 1 is equipped, an intake pipe 105 as a passage to take in air from the outside, and an intake valve 107 to supply fuel spray and the air into a combustion chamber 102 of each cylinder. A fuel spray 90 from the fuel injection valve 1 is fed to the combustion chamber 104 via the intake valve 107 upon valve opening.

The air-fuel mixture fed into the combustion chamber 102 is compressed with a cylinder 103, and ignited via an ignition plug 104. Exhaust gas after combustion is discharged via an exhaust valve 108, and at the exhaust process, passed through a not shown exhaust emission purification catalyst.

As shown in FIG. 24, when the spray 90 from the fuel injection valve 1 is a two directional spray, the fuel is injected toward two intake valves 107 of the internal combustion engine 101. On the other hand, in the case of one directional spray, the fuel injection valve 1 is provided in a position near the intake valve 107 such as injection positions 110a and 110b shown in FIG. 24.

According to the above-described respective embodiments, it is possible to change the direction and form of fuel spray in correspondence with fuel pressure or valve stroke with a simple structure without deterioration of atomized droplet-diameter of the fuel spray. Accordingly, the spray pattern of the injected fuel can be changed.

Further, it is possible to realize a variable spray at a low cost with a simple structure different from the conventional invention (Patent Document 2: JPA 2003-328903) showing a complicated structure using two needle valves.

Further, in the conventional invention (Patent Document D1: JPA 2006-336577), a fuel spray having a penetration although is used to carry a fine-atomized fuel spray, the diameter of each droplet in the fuel spray trends to become large to keep the penetration. In the present embodiment, the change of spray pattern is realized by reflecting the above-described liquid film. Since the diameter of the fine droplet of the fuel spray greatly depends on the thickness of liquid film but does not much depend on the bend of liquid film, it is possible to change the spray pattern without deterioration of the diameter of the fine droplet of the fuel spray.

Further, in the present embodiment, particularly upon cold engine status, the spray is widened to enlarge the spray surface area to promote natural evaporation. Upon engine warming up, the spray is narrowed to be brought to collide with the intake valve, to cause evaporation with incoming heat from the intake valve. This enables improvement in exhaust performance and output performance.

### DESCRIPTION OF REFERENCE SIGNS

1,110 . . . fuel injection valve, 3 . . . valve element, 5 . . . nozzle body, 6 . . . nozzle plate, 7,8,9,10,40 . . . fuel nozzle hole, 32 . . . liquid column, liquid film, 33 (33a to 33f, 33g) . . . step height (fuel flow control portion), 34 (34a to 34f) . . . epression portion, 35 (35a to 35f) . . . projection portion, 36 (36a to 36b) . . . countersunk-like hole portion, 37 . . . projection, 38 . . . step height on valve element, 39 . . . flat face at end of valve element, 41 (41a to 41b) . . . depression portion, 42 (42a to 42b) . . . countersunk-like hole portion 101 . . . internal combustion engine, 102 . . . combustion chamber, 103 . . . cylinder, 104 . . . ignition plug, 105 . . . intake pipe, 106 . . . intake port, 107 . . . intake valve, 108 . . . exhaust valve.

1. A fuel injection valve for an internal combustion engine, having a valve element, a valve seat, multiple fuel nozzle holes provided downstream from the valve seat, a spring for pressing the valve element against the valve seat side, and a valve drive actuator for moving the valve element away from the valve seat against the spring to open the valve based on a valve opening signal, wherein the nozzle holes are constituted by at least a pair of nozzle holes and configured such that, upon valve opening of the injection valve, liquid columns of fuel injected from the pair of nozzle holes collide with each other before break-up of the liquid columns,
the fuel injection valve further comprising a fuel flow control portion that controls a flow of the fuel flowing into at least one of the pair of nozzle holes so as to make swirl forces of the fuel liquid columns injected from the pair of nozzle holes differ from each other.

2. The fuel injection valve according to claim 1, wherein the pair of nozzle holes are set so as to form a liquid film by collision of the injected fuel liquid columns and break up it after liquid film formation, and
wherein regarding the swirl forces of the fuel liquid columns, the fuel flow control portion is configured to apply a swirl force to a fuel injected from one of the pair of nozzle holes while applying a smaller or little swirl force to a fuel injected from the other of the pair of nozzle holes in comparison with the one nozzle hole.

3. The fuel injection valve according to claim 1, wherein the fuel flow control portion is configured to make fuel flow velocity distributions in a circumferential direction at inlets of the pair of nozzle holes differ from each other thereby to make the swirl forces between the nozzle holes differ from each other.

4. The fuel injection valve according claim 1 further comprising a nozzle plate in which the multiple nozzle holes are provided,
wherein a top surface to be an upstream side surface of the nozzle plate is provided with a step height for making a difference in height on the top surface, and thereby the step height configures the fuel flow control portion,
wherein at least one pair of nozzle holes is provided at a lower portion to be a lower surface in the difference in height, wherein one of the pair of nozzle holes at the lower portion is placed close to a wall of the step height such that the inlet of the one of the pair of nozzle holes is subjected to control of the fuel flow with the wall of the step height.

5. The fuel injection valve according to claim 4, wherein a height H of the step height is equal to or greater than ( 1/10)R with respect to a radius R of the nozzle hole radius R, and
wherein a shortest distance between the step height and the pair of nozzle holes is equal to or less than 3R.

6. The fuel injection valve according to claim 1 further comprising a nozzle plate in which the multiple nozzle holes are provided,
wherein a countersunk-like hole portion larger than a diameter of the nozzle hole diameter is provided at an inlet of at least one of the pair of fuel nozzle holes in a top surface to be an upstream side surface in the nozzle plate, and
wherein a wall surface of the countersunk-like hole portion configures the fuel flow control portion by offsetting a center of the countersunk-like hole portion with respect to a center of the nozzle hole provided with the countersunk-like hole portion.

7. The fuel injection valve according to claim 6, wherein the countersunk-like hole portion has a radius equal to or less than 3R with respect to a radius R of the nozzle hole, and a depth equal to or greater than ( 1/10)R.

8. The fuel injection valve according to claim 6, wherein the countersunk-like hole portion is provided at both inlets of the pair of nozzle holes, and at least one of a diameter, an offset amount and a depth of the countersunk-like hole portion is different between the both nozzle holes.

9. The fuel injection valve according to claim 1, further comprising a nozzle plate in which the multiple nozzle holes are provided,
wherein a top surface to be an upstream side surface of the nozzle plate is provided with a local depression portion, and an inlet of one of the pair of nozzle hole is placed in the local hollow portion, and
wherein the local hollow portion has an asymmetric shape with respect to a line connecting between a center of the nozzle plate and the center of the one nozzle hole placed in the local hollow portion, and thereby a part of the inlet of the one nozzle hole is close to a part of an edge wall of the local hollow portion, thus, the edge wall of the local hollow portion configures the fuel flow control portion.

10. The fuel injection valve according to claim 1, further comprising a nozzle plate in which the multiple nozzle holes are provided,
wherein a top surface to be an upstream side surface of the nozzle plate is provided with a projection, and an inlet of one of the pair of nozzle holes is placed close to the projection, thus, a side wall of the projection configures the fuel flow control portion.

11. The fuel injection valve according to claim 1, wherein an end of a movable valve element of the fuel injection valve is provided with a flat face portion and a step height formed at an edge of the flat face portion, and one of the pair of the nozzle holes is placed close to a wall of the step height of the movable valve element such that a wall of the step height configures the fuel flow control portion.

12. The fuel injection valve according to claim 9, wherein a height H of the step height on the valve element side is equal to or greater than ( 1/10)R with respect to a radius of the nozzle hole, and wherein a shortest distance between the step height and the pair of nozzle holes is equal to or less than 3R in a minimum stroke of the valve element upon fuel injection valve drive.

13. The fuel injection valve according to claim 1, wherein the multiple nozzle holes are divided into groups to form two-directional fuel sprays, and each group is provided with the pair of nozzle holes and the fuel flow control portion.

14. A vehicle internal combustion engine having an intake port, an intake valve, an exhaust valve and a cylinder,
wherein the fuel injection valve according to claim 13 is equipped to the intake port, and set so as to travel two-directional fuel sprays injected from the fuel injection valve toward the intake valve, and
wherein the direction of the fuel injected from the pair of nozzle holes is changed by the fuel flow regulator based on at least one of change of fuel pressure and change of valve element stroke amount.

15. The fuel injection valve according to claim 2, wherein the fuel flow control portion is configured to make fuel flow velocity distributions in a circumferential direction at inlets of the pair of nozzle holes differ from each other thereby to make the swirl forces between the nozzle holes differ from each other.
